(19) United States
(12) Patent Application Publication
(10) Pub. No.: US 2015/0084322 A1
(43) Pub. Date: Mar. 26, 2015

(54) DEVICE FOR TARGETED GUIDING OF A WHEEL RELATIVE TO A VEHICLE BODY IN CASE OF A COLLISION AND ADJUSTED WHEEL RIM THEREFORE

(71) Applicant: AUDI AG, Ingolstadt (DE)

(72) Inventors: Friedrich Killian, Hitzhofen (DE); Tobias Kramer, Stammham (DE)

(21) Appl. No.: 14/491,428

(22) Filed: Sep. 19, 2014

(30) Foreign Application Priority Data
Sep. 20, 2013 (DE) 10 2013 015 701.3

(51) Int. Cl. B60R 19/54; B60B 21/02; B62D 21/15

(52) U.S. Cl. CPC B60R 19/54; B62D 21/152; B60B 21/026
USPC 280/784; 301/95.101

(57) ABSTRACT

A device for targeted guiding of a wheel relative to a vehicle body in the case of a collision includes a capture device for the wheel, which when viewed in the transverse direction vehicle is fastened on one end in the region of a longitudinal member of the motor vehicle and on its other free end is arranged with a distance before a wheel arranged in a wheel well, wherein the capture device in case of a collision engages the wheel and fixes and guides the wheel at least during the collision regarding its turning-in movement such that the wheel forms a part of a load path for introducing collision forces into a support structure of a passenger compartment.

### CROSS-REFERENCES TO RELATED APPLICATIONS

This application claims the priority of German Patent Application, Serial No. 10 203 015 701.3, filed Sep. 20, 2013, pursuant to 35 U.S.C. 119(a)-(d), the disclosure of which is incorporated herein by reference.

### BACKGROUND OF THE INVENTION

The invention relates to a device for targeted guiding of a wheel relative to a vehicle body in the event of a collision and an adjusted wheel rim therefore. In particular the device according to the invention is provided for the event of an impact of a vehicle with a obstacle with small vehicle overlap (small overlap crash) or with a small impact surface.

The following discussion of related art is provided to assist the reader in understanding the advantages of the invention, and is not to be construed as an admission that this related art is prior art to this invention.

For improving the safety in modern motor vehicles, automobile manufacturers expend great efforts to define increasingly challenging requirements in so-called crash tests and to develop corresponding safety structures that meet these requirements. In particular so-called offset crash tests are used which call for a certain degree of overlap between the obstacle and the vehicle in the event of an impact. The development of offset crash tests shows a tendency toward including further load cases with small overlap, wherein for example an overlap of only 20% to 25%—defined according to the US American Institute for crash research IIHS as so called small overlap—measured from the obstacle-facing outside of the vehicle without mirror, results in the fact that the conventional longitudinal members of a vehicle body no longer directly participate in the collision and as a result are far less effective or not effective at all as structures for absorbing impact energy. In particular there is the risk that in the event of a collision according to a small overlap scenario, a wheel becomes entangled with the obstacle and due to the enormous forces enters into the passenger compartment through softer regions of the vehicle body without being blocked by the longitudinal member structures before hand.

the degree of damage to a motor vehicle in a frontal collision with an obstacle depends in particular on the speed of the involved vehicle relative to the obstacle and the degree of overlap or the area of the impact surface. A small impact surface is for example given when the vehicle impacts a light post or a tree off center. For such frontal collisions that involve a small impact surface, the state-of-the-art contemplates to cause the vehicle to be deflected past the obstacle or the coalition partner by correspondingly arranged safety structures.

Such a safety structure is disclosed in the German laid open patent application DE 10 2012 217 431 A1, wherein a motor carrier has a deflection device for the event of a collision. The device is in each case provided on an end side of the side member of the motor carrier and absorbs the impact energy in case of a soft collision involving a small impact surface without the impact energy being conducted to the front wheel or the wheel rim of the front wheel. In a simulated collision with high impact energy as provided for by the US Institute for crash research IIHS this deflection device fails because in this case it unfavorably jams the wheel.

The international patent application WO 2005/110815 discloses a deflection device as safety structure for a partially overlapping frontal collision of motor vehicles. This deflection device is in each case arranged in front of the front wheel and protects the front wheel in the event of a collision by forming a kinematic chain, which lies in a horizontal plane, and whose coupler is a deflector which in the case of a frontal impact pivots backwards and is displaced towards the outside of the vehicle. This causes the front wheel to be unfavorably clamped in the wheel case between the deflection device and the motor carrier so that the impact energy is compensated by less stiff vehicle body elements. This may lead to unsafe deformations of the passenger compartment.

In the German laid open patent application DE 10 2010 031 089 A1, a deflection device is described as safety structure which is arranged at a bumper cross member which connects two longitudinal members in the motor space. The deflection device includes a predetermined buckling site, which in case of a collision involving a small impact surface is bent and engages with its outer ends on the inner wheel rim flange of the front wheel and unfavorably jams the front wheel in the turned-in position in the wheel case so that the outer wheel surface forms an attack surface for further forces and/or torques. This makes it possible that in the case of collision the turned-in wheel is pushed further in the direction of the passenger compartment.

WO 2007/101285 A2 discloses a deflection device as a safety structure for motor vehicles which has a left hand a right hand longitudinal member. The deflection device is arranged before a front wheel and is formed by a deflector which protrudes substantially horizontally and obliquely backwards from the longitudinal member and which protects the front wheel in the event of a collision. In order to prevent a hooking in the case of a partially overlapping frontal collision, a deflection shoe is displaceably guided on the deflector. The deflector shoe can be displaced from an idle position in the longitudinal direction of the deflector in an active position and is formed by a slider, which is guided on or in the deflector and by a forward oriented attachment. For partially overlapping frontal collisions involving high impact energies however, the safety structure does not sufficiently protect the passenger compartment from deformations due to the insufficient stiffness. Another disadvantage is also that in the case of a collision this deflection device causes the front wheel to be unfavorably turned in.

The international patent application WO 2012/110529 discloses a vehicle body which has a longitudinal member and a bumper cross member. The vehicle body also includes a cantilever beam as safety element which extends transverse to the longitudinal member along a transverse axis of the vehicle and is fixed on the longitudinal member. The cantilever beam is arranged so as to protrude into an interspace between a wheel receiver and the bumper cross member. As a result of the torsion resistant fixing of the cantilever beam on the longitudinal member the collision energy—in the case of low impact energies—is conducted into the longitudinal member via the cantilever beam without influencing the position of the wheel in the wheel case. In the case of a collision with high impact energy, the scenarios of which are predetermined by the American Institute for crash research IIHS, the deflecting effect of the cantilever beam fails because the torsion resistant fixing of the cantilever beam is not stable enough so that the wheel in such collisions is then unfavorably displaced in the wheel case by the released cantilever beam.

JP 2005 119 537 shows a safety element formed on a bumper which in case of a collision is intended to engage in the rotating wheel, wherein forces that occur in the event of a collision are conducted into the wheels in an uncontrolled and also not directed manner thus failing to prevent a turning-in of the wheels.

JP 2012 228 906 discloses an engagement mechanism as safety element. The engagement mechanism engages on the outer wheel rim flange in the wheel so that depending on the circumstances the wheel is capable during the collision to be turned in outwardly with its front part which points in driving direction, thereby causing the risk that the turned-in wheel is pushed into the passenger compartment.

It would therefore be desirable and advantageous to provide an improved device which has a simple construction and can be easily mounted for targeted guiding of the wheel relative to a vehicle body in the case of a collision which ensures a defined movement or position of the wheel relative to the vehicle body during and/or after a collision, thereby preventing an uncontrolled wheel or an unfavorably positioned wheel from entering a passenger compartment with great impact energy or becoming hooked with the obstacle. It would in particular be desirable to ensure the reproducible effectiveness of such a safety structure, for example in connection with impact tests, in which the obstacle contacts the vehicle outside of an impact-energy-compensating, stiffened structure. Further it would be advantageous to configure such a device so as to be capable of being retrofitted or integrated in existing vehicles or vehicle concepts

### SUMMARY OF THE INVENTION

According to one aspect of the present invention, a device for targeted guiding of a wheel relative to a body of a motor vehicle in the case of a collision, includes a capture device for the wheel, said capture device having a first and which when viewed in a transverse direction of the vehicle is fastened in a region of a longitudinal member of the motor vehicle and a free second end arranged at a distance before a wheel in a wheel well, wherein the capture device engages in the event of a collision with the wheel and fastens or guides the wheel at least during the collision so that the wheel forms a part of a load path for introducing collision forces into a support structure of a passenger compartment.

According to the invention it was recognized that in order to meet the demands of the so called “small overlap crash test” it is required to use the wheel involved in such a collision as part of the load path, wherein collision forces are to be conducted via the wheel into stiff vehicle body structures of the passenger compartment, in particular for example a side sill of the passenger compartment. For this it is necessary to guide the wheel during the collision in a targeted manner and in particular to prevent the wheel from turning in to keep it in a position that is as straight as possible in order to guide the wheel as directly as possible onto a front end of the side sill of the passenger compartment. When this is achieved, significant portions of the collision forces or the energy released by the collision can be conducted onto stiff regions of the passenger compartment via the wheel. It is reliably possible to prevent entering of the wheel in particular the wheel rim through further parts of the wheel case into the foot space of the passenger compartment. In contrast to the state of the art in which often the approach is taken to excessively turn in the wheel in a targeted manner in a small overlap crash test and to use the wheel as deflection plane for the obstacle, the invention takes a different approach.

The device according to the invention has the goal to prevent the wheel participating in the collision, in particular in the small overlap crash, from turning in or to guide the wheel in a targeted manner so that the wheel which can be torn out of parts of the wheel suspension, by additional means so that the wheel during its “rearward movement” within the wheel case reliably impacts a solid vehicle body structure of the passenger compartment. This case represents the optimal case in the sense that—when the wheel impacts a solid vehicle body structure—the wheel itself forms a second load path for introducing collision forces into solid structures of the passenger compartment.

The device according to the invention for targeted guiding of a wheel relative to the passenger compartment in the case of a collision therefore has a capture device for a wheel, which when viewed in the transverse direction of the vehicle is fastened on one end in the region of a longitudinal member of the motor vehicle adjacent to a wheel participating in the collision and is arranged on its other, free end at a distance before a wheel arranged in a wheel case. In the event of an accident the capture device engages with the wheel and fixes or guides the wheel at least during the collision, i.e., at least during its rearward movement until contact with the passenger, compartment regarding its turning-in movement so that the wheel forms a part of a load path for conducting collision forces into a carrier structure of the passenger compartment. The invention assumes a collision with a wheel position in straight ahead drive. When for example in the case of such a wheel position an appropriate carrier structure of the passenger compartment is located already directly behind the wheel viewed in vehicle longitudinal direction, it is an object of the invention to guide the wheel onto this vehicle body structure in a not turned-in state as far as possible. When an appropriate carrier structure of the passenger compartment in the vehicle longitudinal direction is arranged slightly within or outside the wheel, the invention can ensure that the wheel is guided in a targeted manner so that in particular in cooperation with the control arms, which form the wheel control, that the wheel reliably impacts an appropriate stiff and solid vehicle body structure. Hereby it is advantageous that at least until the bursting of a tire of the wheel the latter can still act as a buffer. After the bursting of the tire this buffer effect is essentially eliminated. However, the wheel rim can then act with its entire diameter as energy absorption or energy conducting element to conduct energy into solid carrier structures of the passenger compartment. An advantage of the invention is that for example flanges of a wheel rim can no longer enter into soft and perforable regions of the vehicle body, in particular the passenger compartment, thus minimizing the likelihood that the flanges enter into or perforate vehicle body walls that delimit the foot space.

According to another advantageous feature of the invention, the capture device is configured as thin plate, which is bending soft at least about a vertical axis (Z-axis) of the vehicle. Within the scope of the invention the term bending soft about a vertical axis of the vehicle means that the thin bending soft plate is configured in any case more bending soft in a direction about the vertical axis of the vehicle than about the other vehicle axes, for example the longitudinal axis (X-axis) of the vehicle or the transverse axis (Y-axis) of the vehicle. The configuration of the capture device as bending soft plate, which in a particular embodiment has a course which corresponds to the wheel case contour, enables in particular a space saving construction. In particular this embodiment enables retrofitting for already existing vehicles or for already existing vehicle packaging because the requirement mounting space is very small.

At its free end the capture device has engagement means preferably constructed as claws, which during normal operation of the running surface of the wheel and in case of a collision can become hooked with the tire of the wheel. The hooking and the clawing can be of such intensity so as to cause destruction of the tire. As the case may be however a clawing can also occur which does not perforate the tire and thus retains the tire as buffering element.

In the other extreme case however, hooking with the wheel rim on its base or flange may occur, wherein the tire is usually perforated by the engagement means.

Fastening the first end of the capture device on a subframe, which is usually arranged below a longitudinal carrier of the vehicle, allows on one hand configuring the capture device in a simple manner and on the other hand causing the capture device to engage with the wheel participating in the collision, in particular the front wheel, at about the vertical height of the wheel axis. The same applies when fastening the first end on the console arranged below the longitudinal member or on an endside mounting element fastened on the subframe.

Within the scope of the invention the term subframe is also synonymous with the terms axle carrier, chassis subframe or motor carrier.

As a result the capture device which is in engagement has relative to the turning in axis of the wheel a maximal lever arm which minimizes the forces required form the guiding.

Preferably the fastening of the capture device viewed in longitudinal direction of the vehicle is arranged on the height of the front end of the associated wheel. At least at the height of the front end of the associated wheel means in this cases that the fastening point viewed in driving direction is not located before the front end of the associated wheel when it is positioned in straight ahead driving. This measure enables creating construction space for additional crash protection measures or other components such as charge air cooler or the like. Further, in particular in a configuration of the capture device as rigid pivot claw (as described further below) such a position of the fastening point forms kinematic advantages in order to be able to guide the wheel control until contact with solid support structures of the passenger compartment in a defined manner.

In a configuration as rigid pivot claw it is further preferable to arrange the fastening point or the fastening site of the first end of the capture device as far rearward as possible, in particular by a distance D. Such a forwardly arrowed arrangement of the capture device makes it significantly more easy to conFIG. the course of the capture device to trace the wheel well contour.

According to another advantageous feature of the invention, the capture device is configured as pulling band. In particular the capture device is configured as self-supporting pull strap. The term pull strap in the context of the invention means that the capture device is configured capable of being exposed to pulling loads. “Pull strap” in the context of the invention does not mean a bending-flaccid for example textile strap. Such textile components that are in themselves bending-flaccid, however can be used for forming a pull strap. However, preferably additional measures are employed to at least stiffen the pull strap so that the pull strap is self supporting, i.e., it is sufficiently stiff so that it can protrude cantilevered from its fastening point on the first end into the wheel space without being significantly deformed during by the vibration excitations occurring during the driving operation. In case of a collision the configuration referred to as pulling band is capable to transmit high pulling forces.

“Cantilevered” in the meaning of the invention means that the capture device at its free end or along its course does not require additional solid support measures for achieving the objective of the invention. For this purpose for example additional control arms or couplings or support triangles or the similar junction plates are provided in the state of the art. Of course, the capture device can be supported for example on the wheel arch liner by means of clipping or other means, for example vibration dampening means, in order to avoid undesired noises or vibrations during normal driving operation. It is also possible without departing from the scope of the invention to arrange the capture device such that a wheel arch liner is still arranged between the capture device and the wheel. In the event of a collision the capture device then perforates the wheel arch liner and thus comes into contact with the wheel. Such a configuration has the advantage that within the wheel well a more smooth-surfaced configuration is possible and with this as the case may be undesired aerodynamic-related noise generation in the wheel well can be avoided.

In a further embodiment of the invention, the capture device is configured as bending stiff pivot claw, wherein the pivot claw is supported on its first end for pivoting about a vertical axis or at least approximately about a vertical axis of the vehicle and is in and of itself a support which is bending stiff about all vehicle axes, and which in the region of its free end carries at least one claw, which in case of a collision comes into contact with the wheel or the wheel tire. Such an embodiment is in particular advantageous because such a pivot claw enables in a simple manner upon contact with the wheel to transit compression forces as well as pulling forces and this allows kinematically influencing the wheel in a simple manner.

In a further embodiment a connecting line between a claw tip of the capture device and the fastening site of the capture device on the longitudinal member or on the subframe forms an angle α with the longitudinal direction of the vehicle, wherein the angle α is preferably smaller than 90°, in particular 45° to 90°.

The angle α is preferably selected so that the capture device, in particular in the configuration as bending stiff pivot claw, covers a angular position of α=90° during the rearward displacement of the wheel relative to the vehicle body until the wheel impacts the appropriate solid stiff passenger compartment structure. Particularly preferably the angle α in the stating position is selected so that its value is about the same as an angle (−α) for the case when the wheel in the event of a collision comes into contact with the stiff vehicle body passenger compartment structure. Such an appropriate angle can in particular be determined by means of vehicle body crash simulations and corresponding simulations of the displacement of the wheel during the collision or in real crash tests.

A second aspect of the invention includes a wheel rim, in particular for the device according to the invention, which has a wheel rim base with an inner and an outer wheel rim flange, wherein according to the invention the wheel rim base has at least one circumferential groove or bulge-like elevation which is configured to interact with a capture device according to the invention for preventing a turning-in of the wheel or for targeted guiding. Such a wheel rim has the advantage that when for example a tire is destroyed by the claws on the free end of the capture device according to the invention, the capture device can be safely brought in form fitting contact with the wheel rim. As a result of the circumferential grooves provided in the wheel rim base in contrast to the state of the art in which the wheel rim flanges are used for such an engagement it is ensured that independent of the point of impact of the claws onto the wheel rim base this claw finds a corresponding groove-like indentation thus enabling guiding of the wheel during the collision within a narrower range.

In a preferred embodiment multiple groove like indentations are provided in the wheel rim base and corresponding thereto bulge-like elevations.

The bulge-like elevations are configured to have an acutely tapered cross section, thus facilitating a secure engagement of the claws of the capture device with the wheel even when for example in the case of a collision a piece of the rubber tire may be lodged between the capture device and the wheel rim.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 a schematic bottom view onto a front wheel suspension of a vehicle with the device according to the invention in a first embodiment in which the capture device is configured as bending soft plate/pull strap;

FIG. 2 shows the arrangement according to FIG. 1 in a perspective view;

FIG. 3 shows the first embodiment of the invention according to FIGS. 1 and 2 in a strongly schematized top view in normal position (i.e., prior to the collision);

FIG. 4 shows the device according to the invention according to FIG. 3 in a collision case;

FIG. 5 shows a bottom view onto a wheel suspension having the device according to the invention in a second embodiment, in which the capture device is configured as bending stiff solid pivot claw;

FIG. 6 shows the arrangement according to FIG. 5 in a perspective view;

FIG. 7 shows the arrangement according to the FIGS. 5 and 6 in a strongly schematized top view in the state of a stating collision with an obstacle;

FIG. 8 shows the arrangement according to FIG. 7 in a strongly schematized view during a collision at the time point of impact of the wheel onto a solid passenger compartment structure;

FIG. 9 shows strongly schematized a wheel rim according to the invention in interaction with a device according to the invention in case of a collision.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

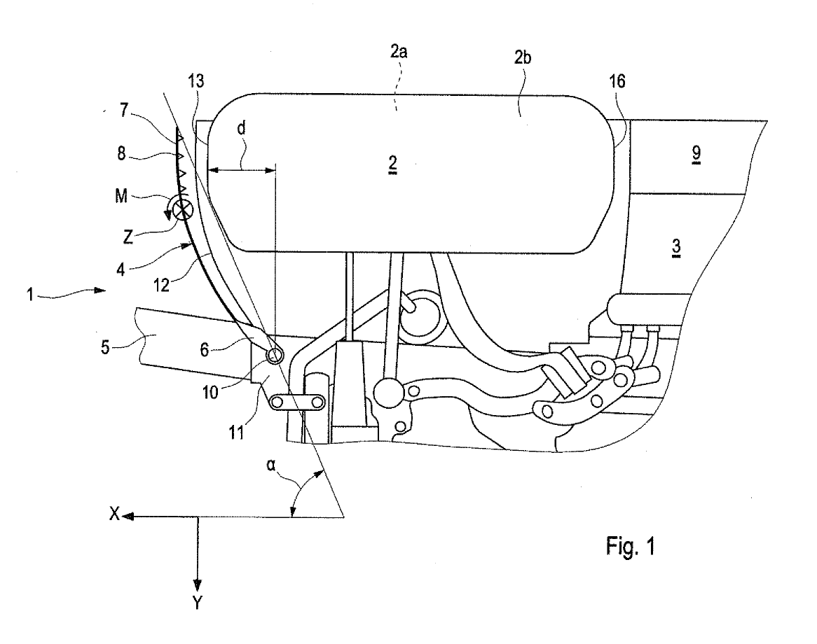

Turning now to the drawing, and in particular to FIG. 1, there is shown a device 1 according to the invention for targeted guiding of a wheel 2 relative to a vehicle body 3. The device 1 has a capture device 4 which has when viewed in a transverse direction Y of the vehicle a first end 6 arranged in the region of a longitudinal member 5 and a free second end 7. On the free end 7 engagement means 8, for example claws are arranged, which in the normal position shown in FIG. 1, are spaced apart in a driving direction X on front of the wheel 2. The engagement means in particular the claws 8 face toward the wheel 2 when viewed in driving direction X.

In the embodiment according to FIG. 1, a solid support structure 9 of the vehicle body, in particular the passenger compartment, for example a side sill is located behind the wheel 2 when viewed in driving direction X.

In the region of the first end 6 the capture device 4 is fastened on a subframe 1 by means of a fastening device 10. The capture device 4 is configured thin-walled and plate-shaped along most of its extend in vehicle transverse direction viewed from the longitudinal member 5 outwardly. The capture device 4 is adjusted with regard to its curvature along its course from inward to outward to the course of the associated wheel well, which is schematically represented in FIG. 1 by a wheel arch liner 12. In the embodiment according to FIG. 1, the capture device 4 can be a sheet metal made of steel or aluminum or stainless steel which is bending soft to moments M about the vertical axis of the vehicle (Z-axis). The capture device 4 can also be configured as pull strap, which for example has a textile core, which is surrounded with a plastic sheath. The pull strap can also be configured for example from weaved and in particular encased steel band or the like. The configuration of the capture device 4 so as to be bending soft about the vertical axis (Z-axis) of the vehicle should in any case enable transmission of the pulling forces generated during a collision and required for guiding the wheel 2 and acting on the capture device 4. In such a collision at least short time compression forces may act on the capture device 4. These compression forces can be absorbed by the capture device 4 according to the embodiment as pull strap or bending soft plate in form of elastic deformation or short time compression.

FIG. 1 shows a forward arrowed arrangement of the capture device 4, in which an angle α between the longitudinal direction X of the vehicle and a connecting line between the fastening device 10 and a claw (engagement means 8) is <90°. As a result in the normal position according to FIG. 1 prior to a collision, the fastening device 10 when viewed in the longitudinal direction X of the vehicle is offset rearwardly by a distance D relative to the front end 13 of the wheel.

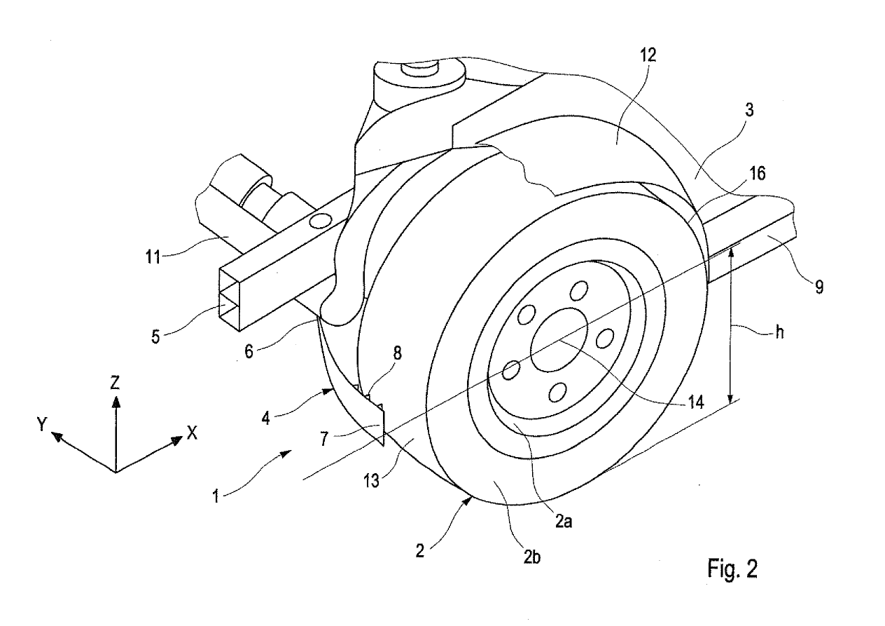

The perspective representation of the device 1 in FIG. 2 illustrates that it is advantageous to fasten the first end 6 of the capture device 4 viewed in vertical height on the subframe 11, because the subframe is usually arranged below the longitudinal member 5 of the vehicle. It is thus possible by cutting the capture device 4 to size in a particularly simple manner to arrange the free second end 7 of the capture device 4 in vertical direction, i.e., in the vertical direction (Z-axis) of the vehicle at about the height h of a wheel axle 14 of the wheel 2. This makes it possible to bring the capture device 4 in contact with the wheel 2 with a maximal lever arm relative to a turn-in axis of the wheel 2.

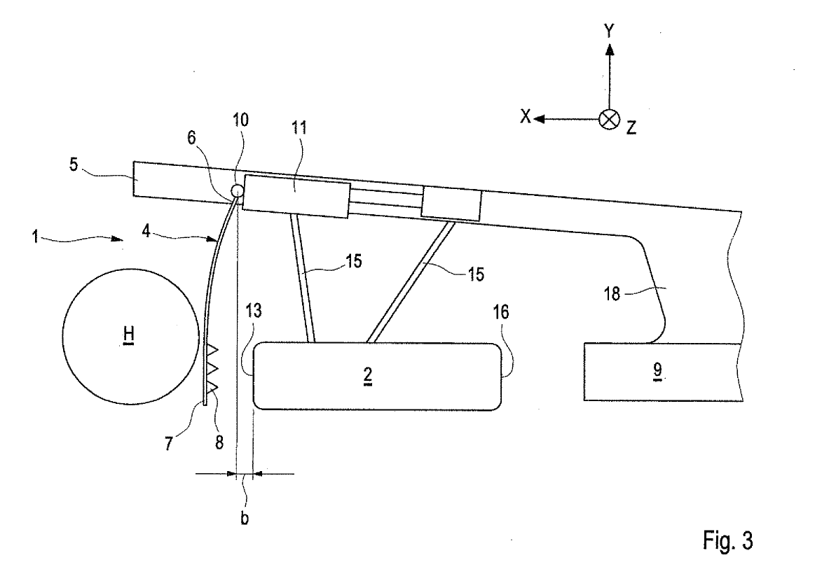

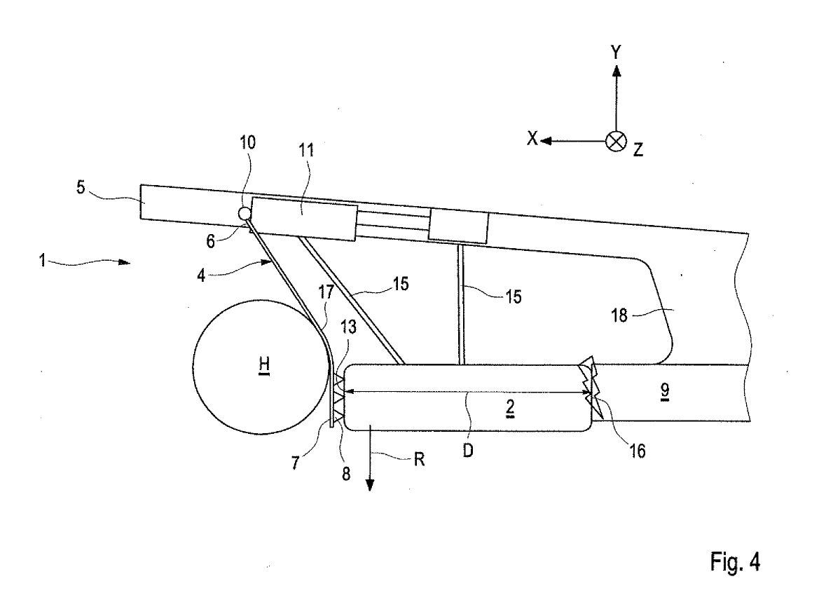

In the following, the functional principle of the device according to the invention is described in its embodiment as pull strap by way of FIGS. 3 and 4. In the representation of FIGS. 3 and 4 in contrast to the description in connection with FIGS. 1 and 2, the fastening device 10 of the capture device 4 is arranged slightly before the front end 13 of the wheel 2 (scale b) when viewed in driving direction X. Such an arrangement may be useful and is particularly preferred when it becomes necessary that after a collision with an obstacle H the capture device 4 has to build up rearward pulling forces as fast as possible already when the wheel 2 is only slightly displaced against driving direction X. In such a case it is useful to arrange the fastening device 10 as the case may be slightly before the end 13 of the wheel 2.

In an embodiment according to FIG. 3 an obstacle H impacts the claw-free side of the capture device 4, which faces in driving direction X in a small overlap collision test. The obstacle H causes the capture device 4 with its engagement means 8 to move toward the wheel 2 so that the engagement means 8 become hooked with a tire 2b or the wheel rim 2a of the wheel 2. Preferably the capture device already begins building up pulling force when becoming hooked with the tire 2b. As a result of the progressing collision (FIG. 4) the wheel 2 is offset rearwardly in the longitudinal direction (X direction) of the vehicle by the obstacle. Hereby a forcible detachment, i.e., a breaking of wheel suspension parts for example control arms 15 can occur. In such a collision situation the wheel 2 usually tends to turn in outwardly in a direction R with its front ends 13, which leads to the known problem of the wheel 2 becoming hooked with the obstacle H.

The device according to the invention 1 ensures by means of the capture device 4, which can transmit pulling forces, that the front end 13 is not or only insignificantly turned in outwardly thereby ensuring that a rear end 16 of the wheel 2 reliably meets the solid support structure 9, for example a side sill of the passenger compartment. As a result of the configuration of the capture device 4 so as to be in particular bending soft about the Z-axis, i.e., for example as a bending soft thin plate or pull strap, it can be bent by the obstacle H (bending region 17) without losing its force transmitting capability and with this its ability to influence the position of the wheel 2. As a result of the impact of the wheel 2 onto the support structure 9 a further load path for introducing collision forces over the entire surface of the wheel 2 into the support structure 9 is established. Of course during this process a tire 2b may burst or be stripped from the wheel rim 2a. Important for the effect according to the invention is however that the wheel rim 2a of the wheel 2 impacts the support structure 9 and does not enter relatively perforation soft regions 18 of a passenger compartment. Such regions 18 are for example separation walls toward the foot space of the passenger compartment. Thus at least the wheel rim 2a is then available as deformable or destructible element as part of a load path for introducing collision forces into the support structure 9. For smaller impact energies the tire 2b may also serve as dampening element.

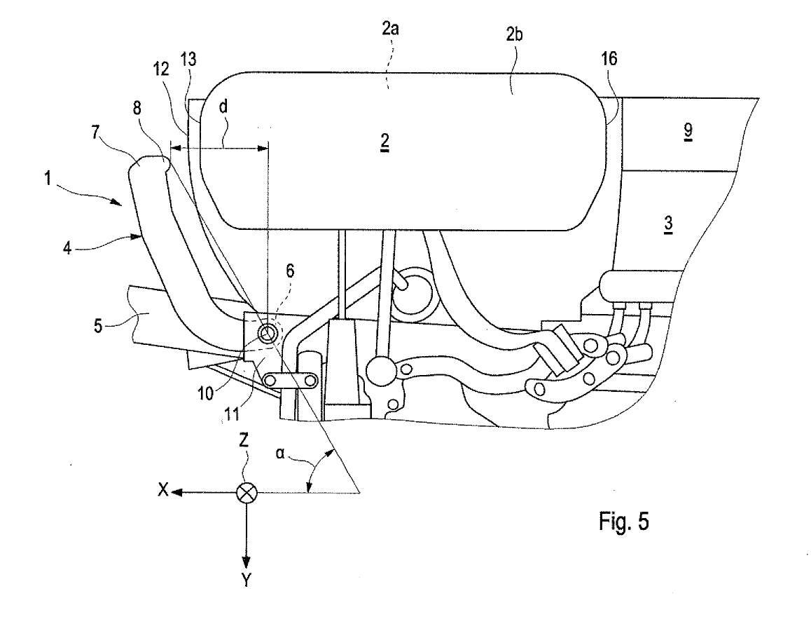

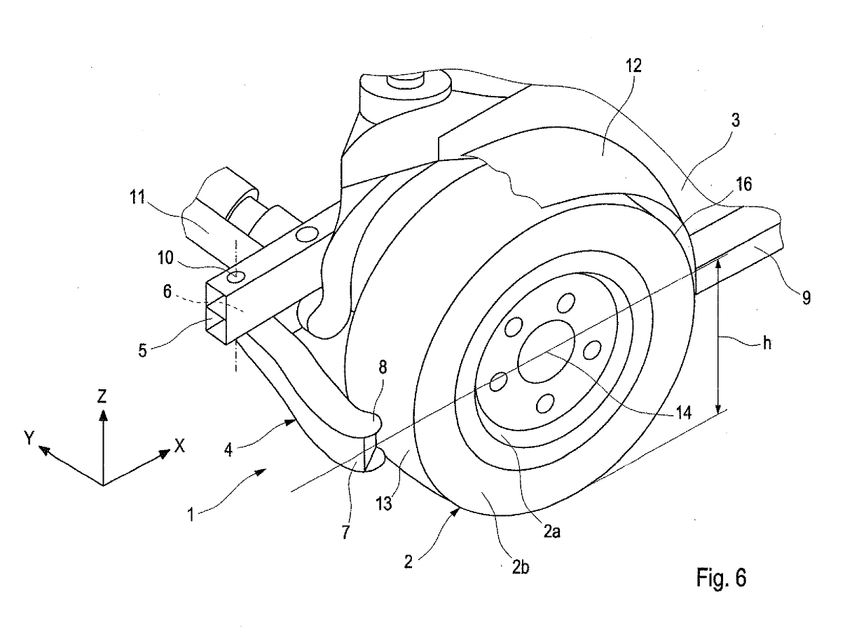

A second embodiment of the device according to the invention is shown in FIGS. 5 and 6, wherein in the following description same elements are designated with the same reference numerals and only the differences of the second embodiment compared to the first embodiment according to FIGS. 1 to 4 are described in more detail.

In contrast to the embodiment according to the FIGS. 1 to 4, in which the capture device 4 is configured as thin bending sift plate or as pulling band, the capture device 4 according to the embodiment according to FIGS. 5 to 8 is configured as solid claw arm which is bending stiff about all vehicle axes, which when viewed in vehicle transverse direction Y is supported pivotal about the vehicle vertical axis Z in the region of the longitudinal member 5 by means of the fastening device 10. In the normal arrangement prior to the collision the capture device 4 is thus arranged forward arrowed (angle α<90°). In particular in the case of the embodiment of the capture device as solid bending stiff claw arm (pivot claw) this has the advantage that during the collision the angle α covers the value 90° and insofar the movement component of the engagement means 8 in vehicle transverse direction Y during the collision is insignificantly small. During the collision the engagement means 8 (claw) performs a movement approximately only in vehicle longitudinal direction X, thereby grasping the wheel 2 or the wheel rim 2a and guiding the wheel 2 in vehicle longitudinal direction X reliably onto the solid structure arranged behind the wheel 2 in vehicle longitudinal direction X. Thus in the event of a collision the configuration of the capture device 4 as rigid claw arm achieves an almost parallel guiding of the wheels 2 parallel to the vehicle longitudinal axis X.

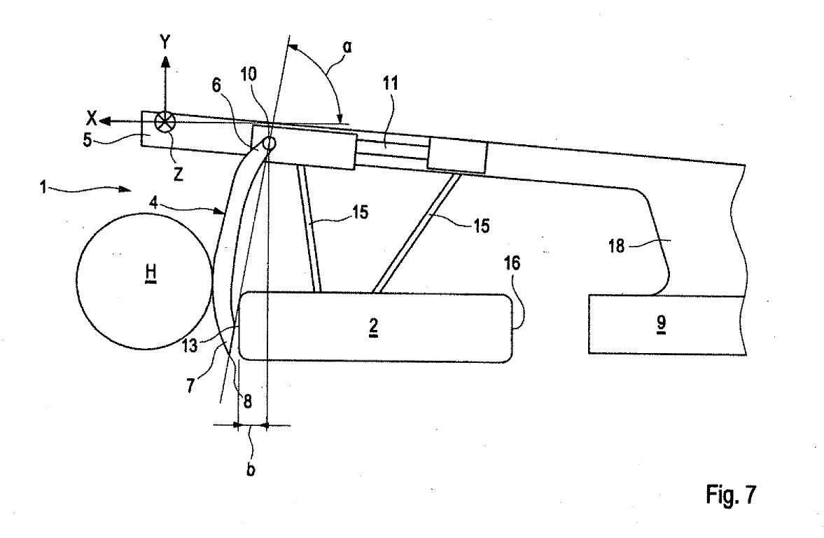

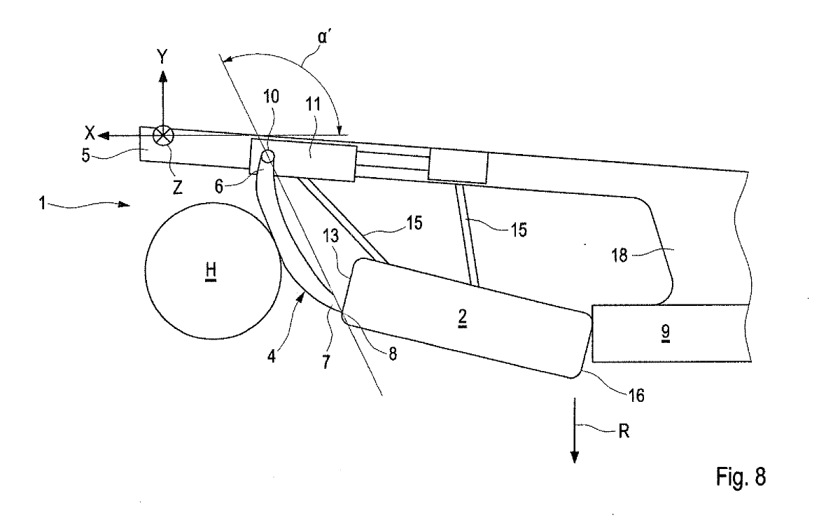

In the following the functioning of the second embodiment is explained by way of FIGS. 7 and 8.

FIG. 7 shows the device according to the invention with the capture device 4 as rigid claw arm during impacting the obstacle H, in particular shortly prior to the contacting of the engagement means 8 with the tire of the wheel 2. Also in this position which is already shown somewhat turned out relative to the normal position according to the FIGS. 5 and 6, the angle α is preferably still less than 90°. During the collision the angle alpha thus covers thus the value α=90° and reaches a position according to FIG. 8 (angle α>90°). During this the wheel 2 may be slightly turned in as shown in FIG. 8 so that its rear end 16 is guided slightly in the direction R. However, this has no significantly disadvantageous consequences because it is still ensured that the wheel 2 impacts the support structures 9. In any case it is ensured that a hooking of the wheel 2 with the obstacle H is prevented which may lead to the rear end 16 entering perforation soft regions 18 of the vehicle body 3. In the embodiment of the invention according to FIGS. 5 to 8 with the capture device as solid claw arm it is particularly advantageous to select the angle α<90° in the starting position. As described before this has kinematical advantages regarding the construction space because with such an arrangement it is constructively particularly easy to adjust the course of the capture device 4 from its fastening site 10 toward the free end 7 to the course of the wheel well in this region.

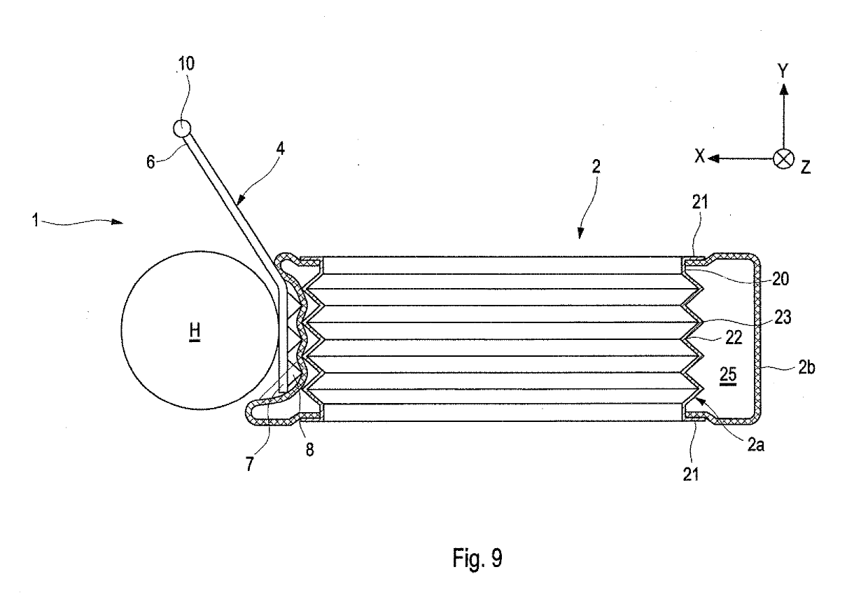

In the following an exemplary embodiment of an optimized wheel rim 2a is shown by way of FIG. 9. Such a wheel rim 2a according to the invention has a wheel rim base 20 and wheel rim flanges 21. Distributed over the width of the wheel rim base 20 are groove-like indentations 22, which are configured circumferential about the wheel rim base 20. The indentations 22 can for example be formed by bulge-like elevations 23. The bulge-like elevations 23 have for example a distance to each other and a cross sectional spatial shape that correspond with the engagement means 8 of the capture device 4, wherein the elevations 23 of or the grooves 22 and the engagement means 8 are geometrically adjusted to each other so that a reliable hooking between the engagement means and the capture device 4 and the wheel rim 2a occurs even when for example a piece of rubber of the tire 2b becomes lodged between the engagement means 8 and the elevations 23 in the case of a collision. In the case of a collision such a configuration of the wheel rim base 20 with a fluid-filled internal space 25 of a wheel 2 causes a more accurate interaction with the device 1 according to the invention and with this a more accurate and more exact, i.e., narrower toleranced guide of the wheel 2. Such a wheel rim 2a according to the invention is in particular advantageous because there is a tendency toward ever wider wheel tire configuration so that—as is the case in the state of the art—a guiding of the wheel rim merely over the wheel rim flanges is too in accurate

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A device for targeted guiding of a wheel relative to a body of a motor vehicle in the case of a collision, comprising:
a capture device for the wheel, said capture device having a first and which when viewed in a transverse direction of the vehicle is fastened in a region of a longitudinal member of the motor vehicle and a free second end arranged at a distance before a wheel in a wheel well, wherein the capture device engages with the wheel in the event of a collision and fastens or guides the wheel regarding a turning-in movement of the wheel at least during the collision so that the wheel forms a part of a load path for introducing collision forces into a support structure of a passenger compartment.

2. The device of claim 1, wherein the capture device is configured as thin plate which is constructed bending soft at least about a vertical axis of the vehicle.

3. The device of claim 1, wherein the bending soft plate has a contour which follows a wheel well contour.

4. The device of claim 1, further comprising engagement means arranged on the second end of the capture device, wherein in the case of a collision said engagement means become hooked with a tire or a wheel rim of the wheel.

5. The device of claim 4, wherein the engagement means are constructed as claws.

6. The device of claim 1, wherein the first end of the capture device is fastened on a subframe or axle carrier of the motor vehicle.

7. The device of claim 1, wherein the capture device when viewed in longitudinal direction of the vehicle is fastened at a height of a front end of an associated wheel.

8. The device of claim 7, wherein the capture device is arranged so as to be rearwardly offset by a predetermined distance.

9. The device of claim 1, wherein the capture device is configured as a pull strap.

10. The device of claim 9, wherein the capture device is configured as a self supporting pulling band.

8. The device of claim 9, wherein the capture device is configured as a bending stiff pivot claw, which is supported in a region of the first end for pivoting about a vertical axis of the motor vehicle relative to the vehicle body.

9. The device of claim 9, wherein a connecting line between one of the engagement means and a fastening site of the first end of the capture device in a starting position is less than 90°, preferably 45 to 90°.

10. The device of claim 9, wherein the capture device in the event of a collision engages with the wheel at a vertical height of a wheel axis of the wheel.

11. A wheel rim, for the device of claim 1, comprising a wheel rim base and wheel rim flanges, said wheel rim base having a circumferential groove, which is configured for interaction with the capture device.

12. The wheel rim of claim 11, provided with multiple grooves extending over an entire width of the wheel rim base.

13. The wheel rim of claim 12, wherein the grooves in cross section are configured corresponding to engagement means of the capture device.
